(19) United States
(12) Patent Application Publication
(10) Pub. No.: US 2018/0036841 A1
(43) Pub. Date: Feb. 8, 2018

(54) POLYMERIC PREASSEMBLY DEVICE AND ASSEMBLY METHOD

(71) Applicant: FORD GLOBAL TECHNOLOGIES, LLC, Dearborn, MI (US)

(72) Inventors: Javier Alberto Gutierrez Andrade, Naucalpan (MX); Christian Arturo Tellez Camacho, Coacalco (MX); Steven Frank, Dearborn, MI (US)

(21) Appl. No.: 15/226,263

(22) Filed: Aug. 2, 2016

(51) Int. Cl. B23K 37/04; F16B 5/06

(52) U.S. Cl. CPC B23K 37/04; F16B 5/0621; B23K 2201/24

(57) ABSTRACT

An assembly includes a first metallic component, a polymeric preassembly device affixed to the first metallic component, and a second metallic component received over the polymeric preassembly device to loosely connect the first metallic component and the second metallic component.

### TECHNICAL FIELD

This disclosure relates generally to an assembly method, and more particularly to loosely connecting first and second metallic components of an assembly using a polymeric preassembly device.

### BACKGROUND

Automotive vehicles are commonly assembled by passing various metallic components through a succession of work stations associated with an assembly line. For example, a vehicle structural frame is assembled by attaching body side assemblies to underbody and roof components (e.g., headers, bows, etc.). Metallic toy tabs are used to connect components of the vehicle structural frame. The toy tabs are designed to prevent the components from disconnecting from one another prior to reaching welding stations of the assembly line. The metallic toy tabs can increase the cost and complexity of the assembly process.

### SUMMARY

An assembly according to an exemplary aspect of the present disclosure includes, among other things, a first metallic component, a polymeric preassembly device affixed to the first metallic component, and a second metallic component received over the polymeric preassembly device to loosely connect the first metallic component and the second metallic component.

In a further non-limiting embodiment of the foregoing assembly, the first metallic component and the second metallic component are sheet metal components.

In a further non-limiting embodiment of either of the foregoing assemblies, the first metallic component is a handoff bracket and the second metallic component is a roof header or roof bow.

In a further non-limiting embodiment of any of the foregoing assemblies, the assembly is a subassembly of a vehicle structural frame.

In a further non-limiting embodiment of any of the foregoing assemblies, the polymeric preassembly device is received through a first opening of the first metallic component and through a second opening of the second metallic component.

In a further non-limiting embodiment of any of the foregoing assemblies, the first opening and the second opening are oval shaped.

In a further non-limiting embodiment of any of the foregoing assemblies, the polymeric preassembly device includes a base and a pin that protrudes from the base.

In a further non-limiting embodiment of any of the foregoing assemblies, fins or projections protrude radially outwardly from the pin.

In a further non-limiting embodiment of any of the foregoing assemblies, the base is positioned proximate a bottom surface of the first metallic structure and the pin is positioned proximate a top surface of the first metallic structure.

In a further non-limiting embodiment of any of the foregoing assemblies, the polymeric preassembly device is rotatable between a first position in which fins or projections of the polymeric preassembly device are aligned with a longitudinal axis of an opening of the first metallic component and a second position in which the fins or projections are perpendicular to the longitudinal axis.

In a further non-limiting embodiment of any of the foregoing assemblies, the polymeric preassembly device includes a pin having a tapered tip portion.

In a further non-limiting embodiment of any of the foregoing assemblies, the polymeric preassembly device includes a base, a pin extending outwardly from the base, and projections that protrude from the pin, and the projections each include an angled surface.

An assembly method according to another exemplary aspect of the present discourse includes, among other things, securing a polymeric preassembly device to a first metallic component, loading a second metallic component over the polymeric preassembly device to loosely connect the first metallic component and the second metallic component, and bonding the first metallic component and the second metallic component together.

In a further non-limiting embodiment of the foregoing assembly method, the method includes removing the polymeric preassembly device after the welding.

In a further non-limiting embodiment of either of the foregoing assembly methods, the securing includes inserting the polymeric preassembly device through an opening of the first metallic component and rotating the polymeric preassembly device to lock its position relative to the first metallic component.

In a further non-limiting embodiment of any of the foregoing assembly methods, fins or projections of the polymeric preassembly device are aligned with a longitudinal axis of the opening during the inserting and are perpendicular to the longitudinal axis after the rotating.

In a further non-limiting embodiment of any of the foregoing assembly methods, the polymeric preassembly device is secured to the first metallic component after the first metallic component arrives at a work station of an assembly line.

In a further non-limiting embodiment of any of the foregoing assembly methods, the loading includes inserting a pin of the polymeric preassembly device through an opening of the second metallic component.

wont In a further non-limiting embodiment of any of the foregoing assembly methods, the bonding includes welding the second metallic component to the first metallic component.

In a further non-limiting embodiment of any of the foregoing assembly methods, the securing includes positioning a base of the polymeric preassembly device proximate to a bottom surface of the first metallic component and positioning a fin or projection of the polymeric preassembly device proximate to a top surface of the first metallic component.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a vehicle structural frame.

FIG. 2 illustrates an assembly that includes a polymeric preassembly device.

FIGS. 3A and 3B illustrate the polymeric preassembly device of the assembly of FIG. 2.

FIG. 4 illustrates another exemplary polymeric preassembly device.

FIGS. 5A, 5B, 5C, and 5D illustrate yet another exemplary polymeric preassembly device.

FIGS. 6, 7, 8, 9, 10, 11 and 12 schematically illustrate an assembly method.

### DETAILED DESCRIPTION

This disclosure describes an assembly and an associated assembly method. The assembly includes a first metallic component and a second metallic component that are loosely connected to one another using a polymeric preassembly device. The polymeric preassembly device temporarily maintains a positioning of the first metallic component relative to the second metallic component prior to welding the metallic components together. These and other features are discussed in greater detail in the following paragraphs of this detailed description.

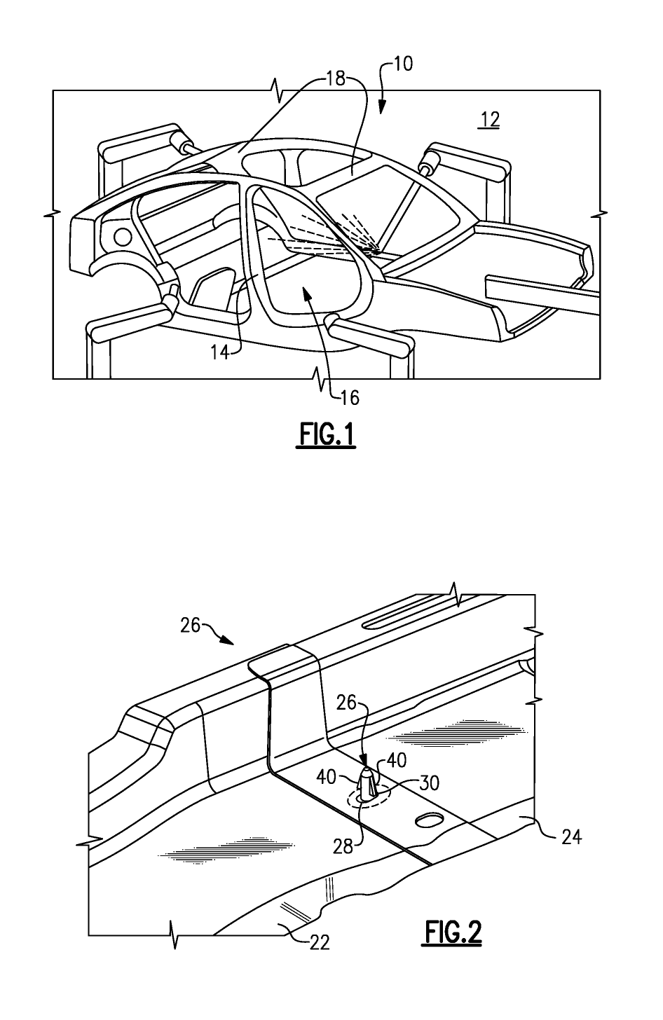

FIG. 1 illustrates an exemplary vehicle structural frame 10. The vehicle structural frame 10 is positioned at a work station 12 of an assembly line. Among various other components, the vehicle structural frame 10 includes body side assemblies 14, an underbody 16, and roof components 18 (e.g., headers, bows, brackets, etc.).

In a non-limiting embodiment, the work station 12 is a welding station of the assembly line. The body side assemblies 14, which may include right and left side assemblies, may be welded to the underbody 16 and the roof components 18 at the work station 12. The vehicle structural frame 10 is depicted in what is referred to as its body in white (BIW) state. BIW generally refers to a state of the vehicle structural frame 10 prior to installation of the powertrain, the exterior trim, and the interior components of a vehicle.

It may be desirable to loosely connect the components of the vehicle structural frame 10 so they are in proper welding position upon reaching the work station 12. This disclosure contemplates polymeric preassembly devices designed for this purpose. In particular, and as described in greater detail below, the polymeric preassembly devices of this disclosure maintain a positioning of the metallic components of an assembly as the assembly passes from work station to work station of an assembly line and prior to reaching welding stations where the metallic components will become permanently connected.

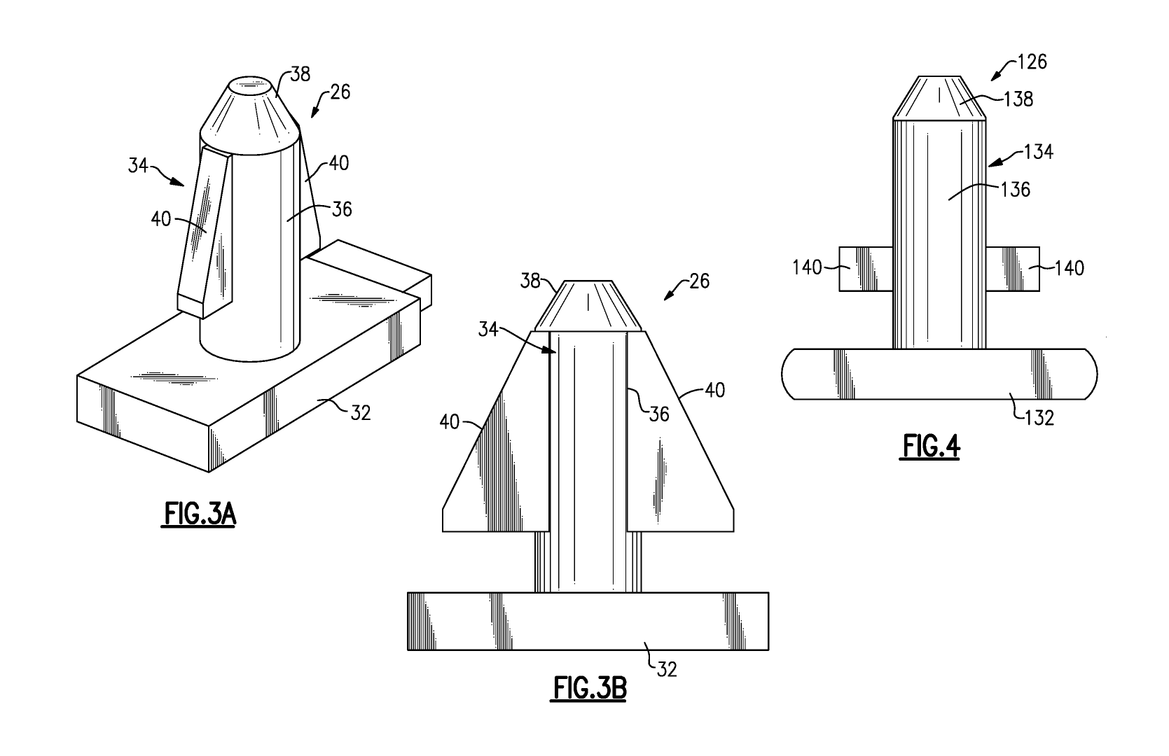

FIG. 2 illustrates an assembly 20. The assembly 20 may be a subassembly of the vehicle structural frame 10 of FIG. 1, for example, or could be any other assembly. It should be understood that the teachings of this disclosure are not limited to vehicle assemblies and could extend to any assembly that is assembled on an assembly line.

The exemplary assembly 20 includes a first metallic component 22, a second metallic component 24, and a polymeric preassembly device 26. The polymeric preassembly device 26 is adapted to loosely connect the first metallic component 22 and the second metallic component 24 to construct the assembly 20. Although a single polymeric preassembly device 26 is shown in FIG. 2, the assembly 20 could employ any number of such devices to loosely, or temporarily, hold metallic components relative to one another.

The polymeric preassembly device 26 is received through an opening 28 of the first metallic component 22 and may then be rotated to affix the polymeric preassembly device 26 to the first metallic component 22. The second metallic component 24 may then be received over the polymeric preassembly device 26 such that it at least partially overlaps the first metallic component 22. The polymeric preassembly device 26 is received through an opening 30 of the second metallic component 24 to loosely connect these components.

The polymeric preassembly device 26 substantially prevents the first and second metallic components 22, 24 from becoming dislodged from one another during an assembly process. For example, in a non-limiting embodiment, the polymeric preassembly device 26 maintains a positioning of the second metallic component 24 relative to the first metallic component 22 as the assembly 20 travels along an assembly line prior to reaching welding stations where the first and second metallic components 22, 24 will be permanently connected.

In a non-limiting embodiment, the first and second metallic components 22, 24 are sheet metal components. In another non-limiting embodiment, the first metallic component 22 is a handoff bracket and the second metallic component 24 is a header or roof bow of a vehicle structural frame. However, other metallic components could also be loosely connected using the polymeric preassembly device 26 or a series of such devices.

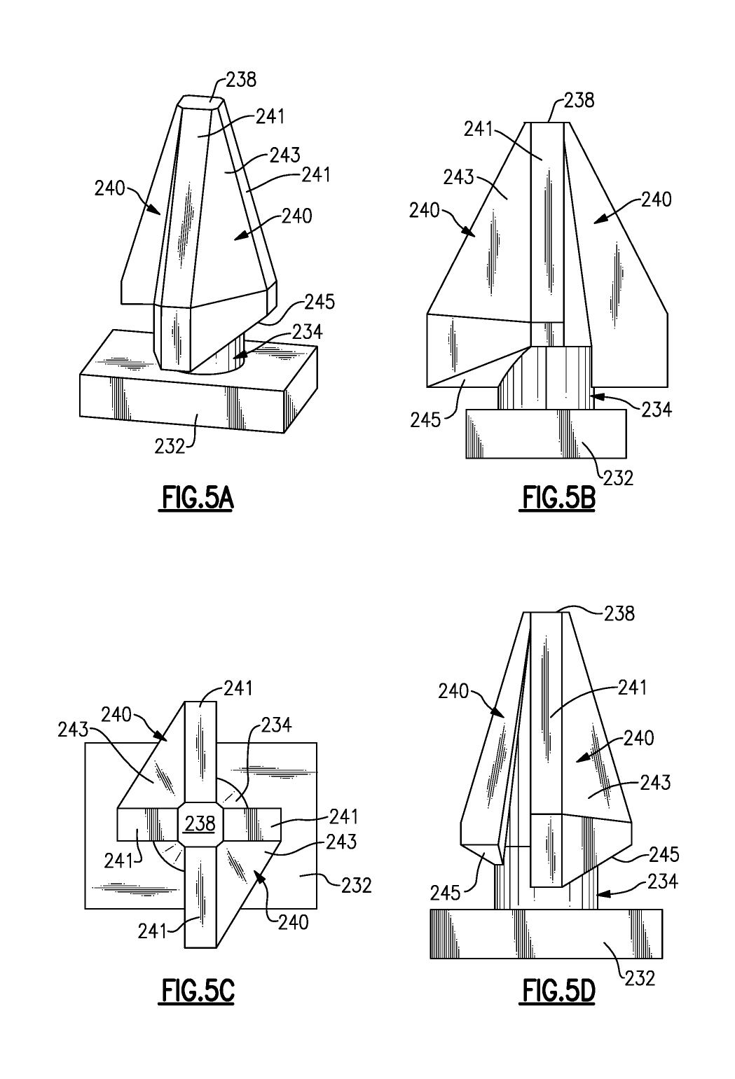

FIGS. 3A and 3B illustrate an exemplary polymeric preassembly device 26. The polymeric preassembly device 26 may be made of any suitable polymer or combination of polymers. In a non-limiting embodiment, the polymeric preassembly device 26 is made of a nylon material.

The polymeric preassembly device 26 may include a base 32 and a pin 34 that protrudes outwardly from the base 32. In a non-limiting embodiment, the base 32 is rectangular and the pin 34 is cylindrical. However, this disclosure is not limited to these specific shapes.

The pin 34 includes a main body 36 that extends to a tapered tip portion 38. In a non-limiting embodiment, the tapered tip portion 38 embodies the shape of a truncated cone. Fins 40, or projections, protrude radially outwardly from the main body 36. Two fins 40 are depicted in the illustrated embodiment; however, the polymeric preassembly device 26 could be designed with more or less fins. In another non-limiting embodiment, the fins 40 taper in a direction that extends from the base 32 toward the tapered tip portion 38.

Referring now to FIGS. 2, 3A, and 3B, the fins 40 and the base 32 facilitate attachment of the polymeric preassembly device 26 to the first metallic component 22. For example, the pin 34 of the polymeric preassembly device 26 may be inserted through the opening 28 of the first metallic component 22 such that the fins 40 are positioned on a first side of the first metallic component 22 and the base 32 is positioned on an opposite side of the first metallic component 22. The polymeric preassembly device 26 may then be rotated to lock the device to the first metallic component 22. Once rotated, the fins 40 create interference with the outer surface of the first metallic component 22 and thus prevent the polymeric preassembly device 26 from falling back through the opening 28. In addition, once locked into place, the pin 34 of the polymeric preassembly device 26 acts as a temporary locator for receiving the second metallic component 24. The first and second metallic components 22, 24 are considered loosely connected to one another once the second metallic component 24 is received over the pin 34 of the polymeric preassembly device 26.

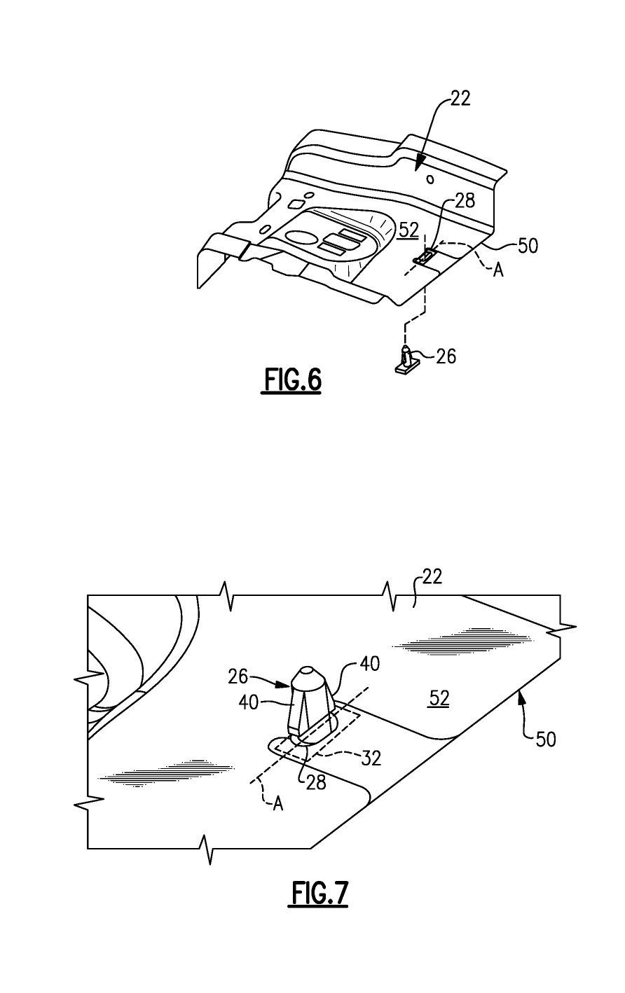

Another exemplary polymeric preassembly device 126 is illustrated in FIG. 4. The polymeric preassembly device 126 includes a slightly modified design compared to the polymeric preassembly device 26 of FIGS. 3A and 3B. In this embodiment, the polymeric preassembly device 126 includes a base 132 and a pin 134 that protrudes outwardly from the base 132. The pin 134 includes a main body 136 that extends to a tapered tip portion 138.

Pegs 140 protrude from the main body 136. In a non-limiting embodiment, the pegs 140 are more proximate to the base 132 than to the tapered tip portion 138. The pegs 140 and the base 132 facilitate attachment of the polymeric preassembly device 126 to other components.

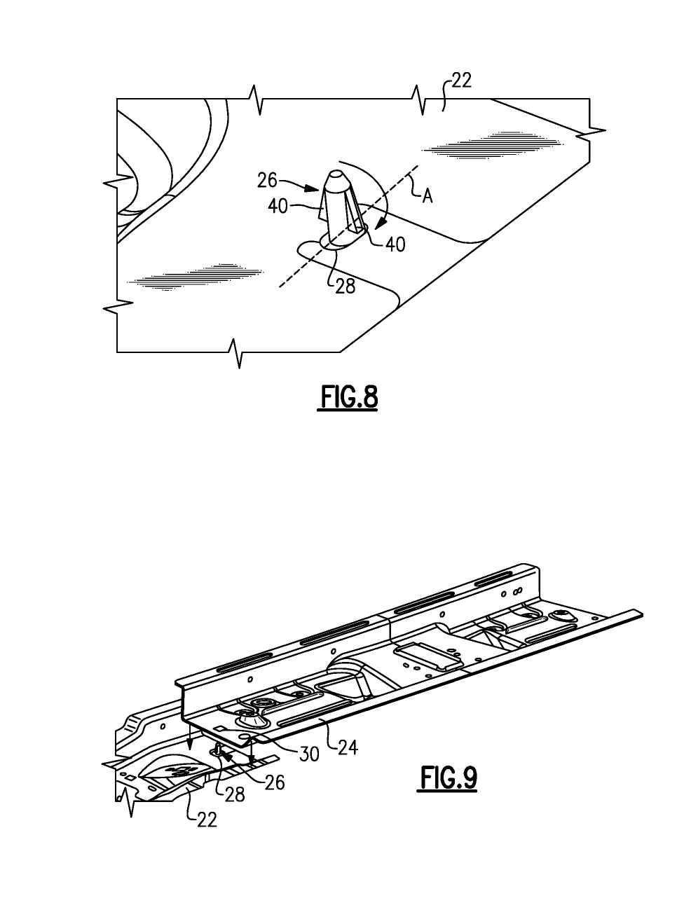

FIGS. 5A, 5B, 5C, and 5D illustrate yet another exemplary polymeric preassembly device 226. The polymeric preassembly device 226 includes a base 232 and a pin 234 that protrudes outwardly from the base 232. The pin 234 may taper toward a tip portion 238.

Projections 240 protrude radially outwardly from the pin 234. Two projections 240 are depicted in the illustrated embodiment; however, the polymeric preassembly device 226 could be designed with more or less projections. In another non-limiting embodiment, the projections 240 are generally triangular shaped. For example, each projection 240 may include arms 241 and a web 243 that extends diagonally between the arms 241 (best illustrated in top view of FIG. 5C).

Together, the projections 240 and the base 232 facilitate attachment of the polymeric preassembly device 226 to a component, such as the first metallic component 22 of FIG. 2. For example, the pin 234 of the polymeric preassembly device 226 may be inserted through the opening 28 of the first metallic component 22 such that the projections 240 are positioned on a first side of the first metallic component 22 and the base 232 is positioned on an opposite side of the first metallic component 22. The polymeric preassembly device 226 may then be rotated to lock the device to the first metallic component 22.

The projections 240 may include angled surfaces 245. The angled surfaces 245 act as lead-in surfaces for receiving and locking the first metallic component 22 between the base 232 and the projections 240 of the polymeric preassembly device 226.

Once rotated, the projections 240 create interference with the outer surface of the first metallic component 22 and thus prevent the polymeric preassembly device 226 from falling back through the opening 28. In addition, once locked into place, the pin 234 of the polymeric preassembly device 226 acts as a temporary locator for receiving another component, such as the second metallic component 24.

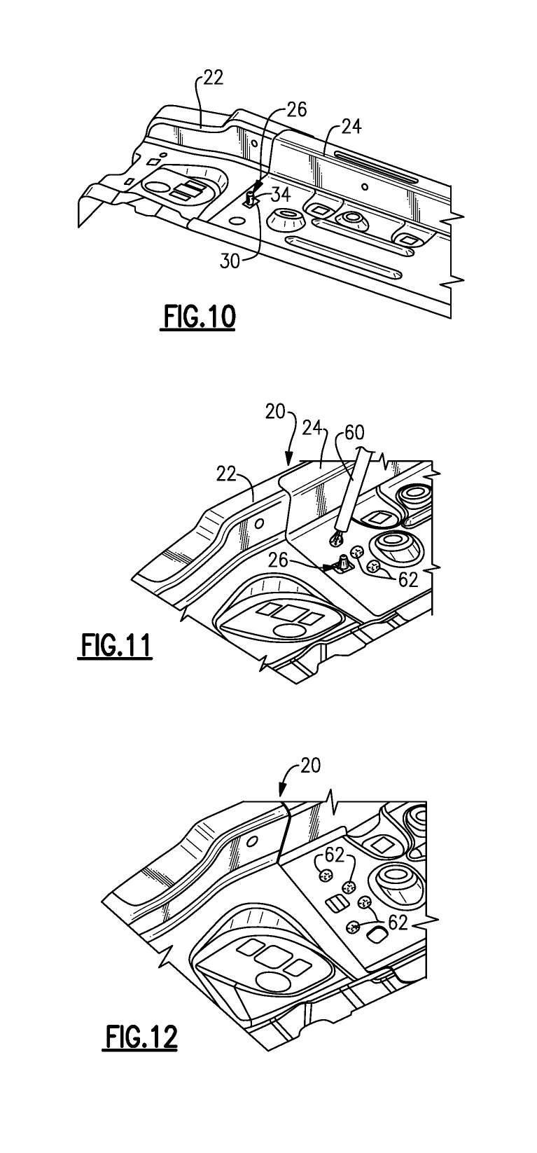

FIGS. 6-12, with continued reference to FIGS. 1-5D, schematically illustrate an exemplary assembly method that utilizes the polymeric preassembly device 26 (or the polymeric preassembly devices 126 or 226). FIGS. 6 through 12 illustrate, in sequential order, a non-limiting embodiment for assembling the assembly 20 of FIG. 2. In a non-limiting embodiment, the assembly 20 is a subassembly of the vehicle structural frame 10. It should be understood that fewer or additional steps than are recited below could be performed and that the recited order of steps is not intended to limit this disclosure.

Referring first to FIGS. 6 and 7, the polymeric preassembly device 26 is inserted through the opening 28 of the first metallic component 22. In a non-limiting embodiment, the opening 28 is oval to facilitate insertion of the polymeric preassembly device 26. The polymeric preassembly device 26 may be inserted from a bottom side of the first metallic component 22 such that the base 32 is positioned proximate a bottom surface 50 of the first metallic component 22 and the fins 40 are positioned proximate a top surface 52 of the first metallic component 22 (best illustrated in FIG. 7). During insertion, the fins 40 of the polymeric preassembly device 26 are substantially aligned with a longitudinal axis A of the opening 28 to ensure that the polymeric preassembly device 26 easily fits through the opening 28.

The polymeric preassembly device 26 is next fixated to the first metallic component 22. As shown in FIG. 8, the polymeric preassembly device 26 may be affixed to the first metallic component 22 by rotating the polymeric preassembly device 26. In a non-limiting embodiment, the polymeric preassembly device 26 is rotated 90 degrees in a clockwise direction to lock it onto the first metallic component 22. Depending on the configuration of the opening 28, the polymeric preassembly device 26 could alternatively be rotated counterclockwise to lock it into position.

In the rotated position shown in FIG. 8, the fins 40 of the polymeric preassembly device 26 are generally perpendicular to the longitudinal axis A of the opening 28. The fins 40 therefore create interference with the material surrounding the opening 28 to prevent the polymeric preassembly device 26 from dislodging from the first metallic component 22.

In a first non-limiting embodiment, the polymeric preassembly device 26 arrives at the assembly line already connected to the first metallic component 22. Stated another way, the polymeric preassembly device 26 may be preassembled to the first metallic component 22. In another non-limiting embodiment, the polymeric preassembly device 26 is affixed to the first metallic component 22 after the first metallic component 22 arrives at the assembly line.

Next, as shown in FIGS. 9 and 10, the second metallic component 24 is loaded over top of the polymeric preassembly device 26, which has already been affixed to the first metallic component 22. The pin 34 (see FIG. 10) of the polymeric preassembly device 26 act as a locator for positioning the second metallic component 24 relative to the first metallic component 22. The pin 34 is received through the opening 30 of the second metallic component 24, which may also be oval shaped. Once the second metallic component 24 is received over the pin 34 of the polymeric preassembly device 26, the first and second metallic components 22, 24 are loosely connected and in proper welding position relative to one another. The second metallic component 24 at least partially overlaps the first metallic component 22 in this loosely connected position.

FIG. 11 schematically illustrates the arrival of the assembly 20 at a welding station of the assembly line. The first and second metallic components 22, 24 are welded together at the welding station. The welding station may utilize one or more welding tools 60 adapted to create multiple weld beads 62 for adjoining the first and second metallic components 22, 24.

Finally, as shown in FIG. 12, the polymeric preassembly device 26 can be removed from the assembly 20 after the welding process. Thus, the weld beads 62 alone hold the positioning of the first and second metallic components 22, 24. The polymeric preassembly device 26 may be removed by rotating it 90 degrees in an opposite direction from the fixation direction (here, counterclockwise).

In yet another non-limiting embodiment, the polymeric preassembly device 26 is a reusable device. Accordingly, the polymeric preassembly device 26 can be used to temporarily connect other sheet metal components once the assembly 20 has been welded.

The polymeric preassembly devices of this disclosure are designed to decrease costs and complexities associated with sheet metal assembly processes. The polymeric preassembly devices do not add weight to the assemblies since they are removed from the final assembly.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An assembly, comprising:
a first metallic component;
a polymeric preassembly device affixed to said first metallic component; and
a second metallic component received over said polymeric preassembly device to loosely connect said first metallic component and said second metallic component.

2. The assembly as recited in claim 1, wherein said first metallic component and said second metallic component are sheet metal components.

3. The assembly as recited in claim 1, wherein said first metallic component is a handoff bracket and said second metallic component is a roof header or roof bow.

4. The assembly as recited in claim 1, wherein said assembly is a subassembly of a vehicle structural frame.

5. The assembly as recited in claim 1, wherein said polymeric preassembly device is received through a first opening of said first metallic component and through a second opening of said second metallic component.

6. The assembly as recited in claim 5, wherein said first opening and said second opening are oval shaped.

7. The assembly as recited in claim 1, wherein said polymeric preassembly device includes a base and a pin that protrudes from said base.

8. The assembly as recited in claim 7, comprising fins or projections that protrude radially outwardly from said pin.

9. The assembly as recited in claim 7, wherein said base is positioned proximate a bottom surface of said first metallic structure and said pin is positioned proximate a top surface of said first metallic structure.

10. The assembly as recited in claim 1, wherein said polymeric preassembly device is rotatable between a first position in which fins or projections of said polymeric preassembly device are aligned with a longitudinal axis of an opening of said first metallic component and a second position in which said fins or projections are perpendicular to said longitudinal axis.

11. The assembly as recited in claim 1, wherein said polymeric preassembly device includes a pin having a tapered tip portion.

12. The assembly as recited in claim 1, wherein said polymeric preassembly device includes a base, a pin extending outwardly from said base, and projections that protrude from said pin, and said projections each include an angled surface.

13. An assembly method, comprising:
securing a polymeric preassembly device to a first metallic component;
loading a second metallic component over the polymeric preassembly device to loosely connect the first metallic component and the second metallic component; and
bonding the first metallic component and the second metallic component together.

14. The assembly method as recited in claim 13, comprising removing the polymeric preassembly device after the welding.

15. The assembly method as recited in claim 13, wherein the securing includes:
inserting the polymeric preassembly device through an opening of the first metallic component; and
rotating the polymeric preassembly device to lock its position relative to the first metallic component.

16. The assembly method as recited in claim 15, wherein fins or projections of the polymeric preassembly device are aligned with a longitudinal axis of the opening during the inserting and are perpendicular to the longitudinal axis after the rotating.

17. The assembly method as recited in claim 13, wherein the polymeric preassembly device is secured to the first metallic component after the first metallic component arrives at a work station of an assembly line.

18. The assembly method as recited in claim 13, wherein the loading includes inserting a pin of the polymeric preassembly device through an opening of the second metallic component.

19. The assembly method as recited in claim 13, wherein the bonding includes welding the second metallic component to the first metallic component.

20. The assembly method as recited in claim 13, wherein the securing includes positioning a base of the polymeric preassembly device proximate to a bottom surface of the first metallic component and positioning a fin or projection of the polymeric preassembly device proximate to a top surface of the first metallic component.
